(19) United States
(12) Patent Application Publication
(10) Pub. No.: US 2021/0124018 A1
(43) Pub. Date: Apr. 29, 2021

(54) LIDAR with Field of View Extending Window

(71) Applicant: Waymo LLC, Mountain View, CA (US)

(72) Inventors: Blaise Gassend, Mountain View, CA (US); Pierre-Yves Droz, Mountain View, CA (US); Ralph Shepard, Mountain View, CA (US)

(21) Appl. No.: 16/660,949

(22) Filed: Oct. 23, 2019

(51) Int. Cl. G01S 7/484; G01S 17/89; G01S 17/10

(52) U.S. Cl. CPC G01S 7/484; G01S 17/10; G01S 17/89

(57) ABSTRACT

The present disclosure relates to systems, methods, and vehicles that could include a rotatable base configured to rotate about a first axis and a refractive optical window coupled to the rotatable base. The refractive optical window includes a flat window portion and a prism window portion or a curved refractive optical window. The LIDAR system could additionally include a mirror assembly coupled to the rotatable base. The mirror assembly includes a plurality of reflective surfaces. The mirror assembly is configured to rotate about a second axis. The second axis is substantially perpendicular to the first axis. The LIDAR system also includes a light-emitter device coupled to the rotatable base. The light-emitter device is configured to emit light pulses that interact with the mirror assembly and the refractive optical window such that the light pulses are directed into a first field of view within an environment of the LIDAR system.

### BACKGROUND

A conventional Light Detection and Ranging (LIDAR) system may utilize a light-emitting transmitter (e.g., a laser diode) to emit light pulses into an environment. Emitted light pulses that interact with (e.g., reflect from) objects in the environment can be received by a receiver (e.g., a photodetector) of the LIDAR system. Range information about the objects in the environment can be determined based on a time difference between an initial time when a light pulse is emitted and a subsequent time when the reflected light pulse is received.

### SUMMARY

The present disclosure generally relates to light detection and ranging (LIDAR) systems, which may be configured to obtain information about an environment. Such LIDAR devices may be implemented in vehicles, such as autonomous and semi-autonomous automobiles, trucks, motorcycles, and other types of vehicles that can move within their respective environments.

In a first aspect, a light detection and ranging (LIDAR) system is provided. The LIDAR system includes a rotatable base configured to rotate about a first axis and a refractive optical window coupled to the rotatable base. The refractive optical window includes: i) a flat window portion and a prism window portion or ii) a curved refractive optical window. The LIDAR system also includes a mirror assembly coupled to the rotatable base. The LIDAR system includes a light-emitter device coupled to the rotatable base. The light-emitter device is configured to emit light pulses that interact with the mirror assembly and the refractive optical window such that the light pulses are directed into a first field of view within an environment of the LIDAR system.

In a second aspect, a method is provided. The method includes causing a light-emitter device to emit light pulses. A first portion of the light pulses interact with a refractive optical window such that the light pulses are directed into a first field of view within an environment. The refractive optical window includes: i) a flat window portion and a prism window portion or ii) a curved refractive optical window. The method also includes receiving at least a first portion of reflected light pulses from the first field of view as a first detected light signal. The method further includes determining, based on the first detected light signal, a first point cloud indicative of objects within the first field of view.

In a third aspect, a vehicle is provided. The vehicle includes a light detection and ranging (LIDAR) system, which includes a rotatable base configured to rotate about a first axis. The LIDAR system also includes a refractive optical window coupled to the rotatable base. The refractive optical window includes: i) a flat window portion and a prism window portion or ii) a curved refractive optical window. The vehicle additionally includes a mirror assembly coupled to the rotatable base. The LIDAR system additionally includes a light-emitter device coupled to the rotatable base. The light-emitter device is configured to emit light pulses that interact with the mirror assembly and the refractive optical window such that the light pulses are directed into a first field of view within an environment of the LIDAR system.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 illustrates a LIDAR system, according to an example embodiment.

FIG. 2A illustrates a LIDAR system, according to an example embodiment.

FIG. 2B illustrates a LIDAR system, according to an example embodiment.

FIG. 2C illustrates a portion of the LIDAR system of FIG. 2A, according to an example embodiment.

FIG. 2D illustrates a LIDAR system, according to an example embodiment.

FIG. 3A illustrates a LIDAR system, according to an example embodiment.

FIG. 3B illustrates a LIDAR system, according to an example embodiment.

FIG. 4A illustrates an operating scenario, according to an example embodiment.

FIG. 4B illustrates an operating scenario, according to an example embodiment.

FIG. 5A illustrates a vehicle, according to an example embodiment.

FIG. 5B illustrates a vehicle, according to an example embodiment.

FIG. 5C illustrates a vehicle, according to an example embodiment.

FIG. 5D illustrates a vehicle, according to an example embodiment.

FIG. 5E illustrates a vehicle, according to an example embodiment.

FIG. 6 illustrates an operating scenario, according to an example embodiment.

FIG. 7 illustrates a method, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

Autonomous and semi-autonomous vehicles may utilize a three-dimensional (3D) LIDAR system for navigation by mapping out an environment of the vehicle based on a LIDAR point map. However, conventional LIDARs have “blind spots”, such as a limited range of elevations it can see down to, leaving a cone below the LIDAR within which it cannot sense objects.

A LIDAR system may obtain spatial range information about an environment by measuring a round-trip time between a first time (e.g., a time at which a light pulse is emitted and a second time (e.g., a time at which the light pulse is received after interacting with the environment). In an example embodiment, the LIDAR system may emit a plurality of light pulses into the environment by way of an optical window. That is, light pulses may be transmitted through the optical window toward objects in the environment.

In some example embodiments, the optical window could be arranged so as to adjust various properties of the light pulses that are transmitted through it. For example, in a scenario where light pulses are generally incident over an 80 degree angle range, the optical window could be shaped or otherwise arranged to provide a wider angle range upon transmission of the light pulses into the environment.

In an example embodiment, the optical window could include a prism configured to spread the light pulses over a rotated angle range compared to a “flat” optical window. In other embodiments, the optical window could be separated into two or more portions. A first portion could include a flat window and a second portion could include a prism-type window. In some embodiments, the optical window could be curved or otherwise shaped to provide a desired light pulse angle range. In an example embodiment, an optical prism element could be attached or otherwise optically coupled to a flat window. In such scenarios, the optical prism element could be glued to the flat window with an index-matching glue (e.g., epoxy).

In example embodiments, the different window portions could be separated by blackened (e.g., opaque) materials. In such scenarios, the width of the opaque material that separates the two portions of the optical window could be wider than the beam width so as to avoid shooting two light pulses in different directions, which could lead to ambiguous or incorrect range information. Additionally or alternatively, the opaque material could provide the capability to shoot light pulses close to the edge of the non-opaque region without causing the beam to split. This provides a wider field of view near the transition than compared to without the opaque material. In such scenarios, light beams that are hitting the opaque region do lose some power and hence some range.

In some embodiments, a prism-type window could add astigmatism or other types of distortion to the light pulses. To compensate for these effects, a further window layer could be added so as to reduce or mitigate the distortion.

In some embodiments, one or more of the optical windows could be formed from molded plastic (e.g., acrylic). However, other materials (e.g., glass, quartz, sapphire, etc.) are contemplated and possible.

The LIDAR system disclosed herein could be used in machine vision and/or perception applications. Additionally or alternatively, in some embodiments, the LIDAR system could be utilized for transportation applications (e.g., semi- or fully-autonomous vehicles) or robotic, security, and/or warehouse-related applications.

### II. Example Systems

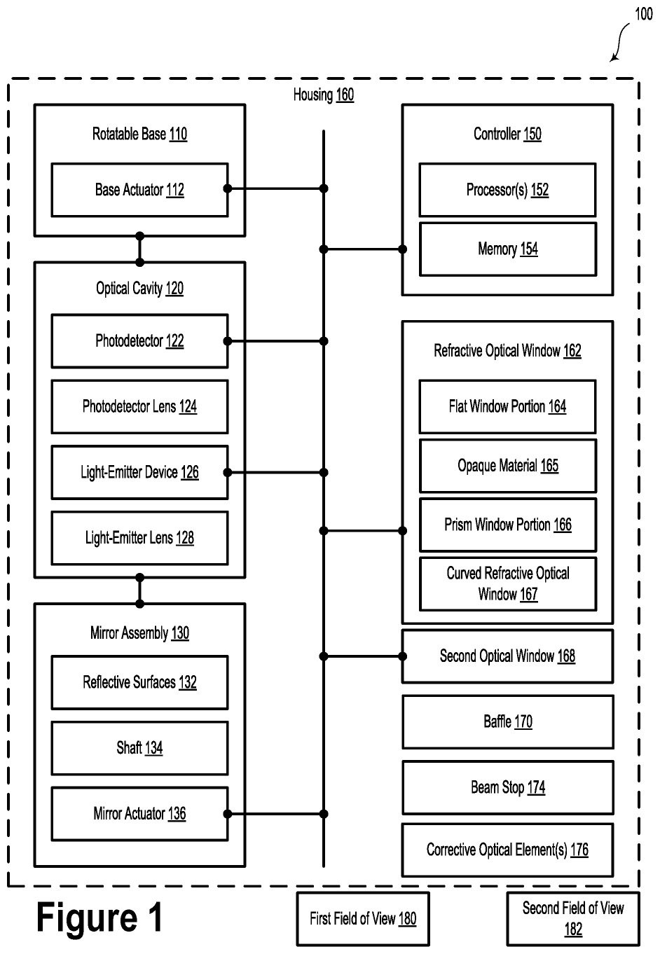

FIG. 1 illustrates a LIDAR system 100, according to an example embodiment. LIDAR system 100 is configured to emit light pulses into an environment so as to provide information indicative of objects within a first field of view 180 and, optionally, a second field of view 182. In some embodiments, the first field of view 180 and the second field of view 182 are not fully overlapping. As an example, the first field of view 180 could include a first elevation angle range and the second field of view 182 includes a second elevation angle range. In such scenarios, the first elevation angle range could be greater than the second elevation angle range. That is, the light pulses emitted into the first field of view 180 are emitted into a larger angular spread than that of the second field of view 182. For example, the first elevation angle range could be greater than 80 degrees (e.g., 95 degrees, 105 degrees, etc.) and the second elevation angle range could be 80 degrees or less. It will be understood the other elevation angle ranges are possible and contemplated. In some embodiments, the first field of view 180 could have two or more continuous angle ranges (e.g., a “split” field of view).

In some example embodiments, LIDAR system 100 could include a rotatable base 110 configured to rotate about a first axis. The rotatable base 110 could include, or could be coupled to, a base actuator 112. In some embodiments, the base actuator 112 could be a direct current (DC) motor, a brushless motor, or another type of rotational actuator. In some examples, the rotatable base 110 could be configured to rotate about the first axis at between 200 revolutions per minute (RPM) and 800 RPM. It will be understood that the rotatable base 110 could operate at other rotational speeds. For example, the rotatable base 110 could rotate about the first axis at a rotational rate between 3 Hz-15 Hz. In some embodiments, the base actuator 112 could be controlled by the controller 150 to rotate at a desired rotational speed. In some embodiments, LIDAR system 100 need not include a rotatable base. In such scenarios, one or more elements of the LIDAR system 100 within housing 160 may be configured to rotate about the first axis. However, in other cases, some elements of the LIDAR system 100 need not rotate about the first axis. Accordingly, in such embodiments, LIDAR system 100 could be utilized in line-scanning applications, among other possibilities.

The LIDAR system 100 also includes a mirror assembly 130. The mirror assembly 130 is configured to rotate about a second axis. In such scenarios, the second axis could be substantially perpendicular to the first axis (e.g., within 0 to 10 degrees of perpendicular). In some embodiments, the mirror assembly 130 includes a plurality of reflective surfaces 132. Additionally, the mirror assembly 130 could include a shaft 134 and a multi-sided mirror that is configured to mount the plurality of reflective surfaces 132. The mirror assembly 130 could also include a mirror actuator 136, which could be a DC motor, brushless motor, or another type of rotational actuator. In such scenarios, the mirror actuator 136 is coupled to the shaft 134. In some embodiments, the mirror actuator 136 could be configured to rotate the multi-sided mirror about the second axis at a rotational speed between 20,000 RPM and 40,000 RPM. It will be understood that the mirror actuator 136 could be operated at various rotational speeds or a desired rotational speed, which could be controlled by the controller 150.

In such scenarios, the plurality of reflective surfaces 132 could include three reflective surfaces arranged symmetrically about the second axis such that at least a portion of the mirror assembly 130 has a triangular prism shape. It will be understood that the mirror assembly 130 could include more or less than three reflective surfaces. Accordingly, the mirror assembly 130 could be shaped as a multi-sided prism shape having more or less than three reflective surfaces. For example, the mirror assembly 130 could have four reflective surfaces. In such scenarios, the mirror assembly 130 could have a square or rectangular cross-section.

LIDAR system 100 additionally includes an optical cavity 120 coupled to the rotatable base 110. In such scenarios, the optical cavity 120 includes a photodetector 122 and a photodetector lens 124 that are arranged so as to define a light-receiving axis. As such, an arrangement of the photodetector 122 and the photodetector lens 124 provide the light-receiving axis. In some embodiments, the photodetector 122 comprises a silicon photomultiplier (SiPM). However, other types of photodetectors, such as avalanche photodiodes (APDs) are contemplated. Furthermore, while photodetector 122 is described in the singular sense herein, it will be understood that systems incorporating multiple photodetectors, such as a focal plane array, are also possible and contemplated.

In example embodiments, the photodetector 122 could provide an output signal to the controller 150. For example, the output signal could include information indicative of a time of flight of a given light pulse toward a given portion of the field of view of the environment. Additionally or alternatively, the output signal could include information indicative of at least a portion of a range map or point cloud of the environment.

For instance, in example embodiments, the photodetector 122 is configured to receive a first portion of reflected light pulses by way of the refractive optical window 162 so as to provide information indicative of objects within the first field of view 180. Furthermore, the photodetector 122 could be further configured to receive a second portion of reflected light pulses by way of the second optical window 168 so as to provide information indicative of objects within the second field of view 182.

The LIDAR system 100 also includes a light-emitter device 126 and a light-emitter lens 128 that are arranged so as to define a light-emission axis. The light-emitter device 126 could include a laser diode or another type of light-emitter. In some embodiments, the light-emitter device 126 could be coupled to a laser pulser circuit operable to cause the light-emitter device 126 to emit one or more laser light pulses. In such scenarios, the laser pulser circuit could be coupled to a trigger source, which could include controller 150. The light-emitter device 126 could be configured to emit infrared light (e.g., light having a wavelength between 800-1600 nanometers). However, other wavelengths of light are possible and contemplated.

In some embodiments, the light-emitter device 126 is configured to emit light pulses (by way of light-emitter lens 128) that interact with the mirror assembly 130 and the refractive optical window 162 such that the light pulses are redirected toward a first field of view within an environment (e.g., an external environment of a vehicle). In such scenarios, at least a portion of the light pulses are reflected back toward the LIDAR system 100 and received by the photodetector 122 (by way of photodetector lens 124) so as to determine at least one of a range or a point cloud.

At least one light source (e.g., the light-emitter device 126) of the LIDAR system 100 could be configured to emit light pulses. The emitted light pulses interact with the environment to provide return light pulses. At least one detector (e.g., the photodetector 122) of the LIDAR system 100 could be configured to detect at least a portion of the return light pulses.

The housing 160 of LIDAR system 100 includes a refractive optical window 162 coupled to the rotatable base 110. In an example embodiment, the refractive optical window 162 includes a flat window portion 164 and a prism window portion 166.

Additionally or alternatively, the refractive optical window 162 could include a curved refractive optical window 167. The curved refractive optical window 167 could include, for example, a continuously-variable-thickness optical window. In such scenarios, the curved refractive optical window 167 could have a continuously-varying optical power as a function of elevation angle with respect to the mirror assembly 130. Other types of curved refractive optical windows are possible and contemplated. In some embodiments, the curved refractive optical window 167 may “stretch” the field of view and/or may act as a variable prism. In other words, the curved refractive optical window 167 could provide an extended field of view (compared to a flat optical window) in exchange for some loss or degradation in the quality of the optical beam. For example, due at least in part to the curved regions of the optical window, the transmitted beam could exhibit astigmatism and other optical aberrations. The curved refractive optical window 167 could include flat and curved portions, which could be arranged so as to expand, compress, or non-linearly remap the scan angles from the mirror assembly 130.

The refractive optical window 162 could be substantially transparent to light having wavelengths such as those of the emitted light pulses. For example, the refractive optical window 162 could include transparent materials configured to transmit the emitted light pulses with a transmission efficiency greater than 80% in the infrared wavelength range. In some embodiments, the housing 160 could include more than one refractive optical window 162.

In some embodiments, the prism window portion 166 includes at least one of: a wedge prism, an equilateral prism, a Littrow prism, a right-angle prism, a penta prism, a half-penta prism, or a rhomboid prism.

In various embodiments, the refractive optical window 167 could be optically coupled to at least one corrective optical element 176. The corrective optical element 176 could be configured to perform at least one optical correction on the emitted light pulses. In such scenarios, the at least one optical correction could include at least one of: astigmatism correction, focus correction, defocus correction, or beam angle correction. For example, corrective optical elements 176 (e.g., collimation optics) could be optically coupled to the light-emitter device 126, the light-emitter lens 128, the photodetector 122, and/or the photodetector lens 124. Such corrective optical elements 176 could be configured to compensate or correct for optical aberrations introduced by the refractive optical window 162 (e.g., due to continuously varying optical power of a curved optical element) or other elements in the optical path of system 100. It will be understood that other types of optical elements are possible that may be configured to interact with emitted light pulses and/or redirect the light pulses into the first field of view 180.

In example embodiments, at least a portion of the refractive optical window 162 (e.g., the prism window portion 166, the flat window portion 164, or the curved refractive optical window 167) could be formed from at least one of: a polymeric material (e.g., polycarbonate, acrylic, etc.), glass, quartz, or sapphire. It will be understood that other optical materials that are substantially transparent to infrared light are possible and contemplated. In some embodiments, the prism window portion 166 could be coupled to the flat window portion 164 by way of an index-matching material. As an example, the index-matching material could include an epoxy material or another type of optical index-adjusting adhesive or fixant. Additionally or alternatively, the prism window portion 166 could be a single non-bonded component.

In some embodiments, an opaque material 165 could be arranged between the flat window portion 164 and the prism window portion 166. As an example, the opaque material 165 could include black tape, absorptive paint, carbon black, or another type of optically opaque, anti-reflective surface or material.

In some embodiments, the housing 160 of LIDAR system 100 could include a second optical window 168 coupled to the rotatable base 110. The second optical window 168 could be arranged on a substantially opposite side of the housing 160 from refractive optical window 162. However, other arrangements of the optical windows are possible and contemplated. The second optical window 168 includes a flat wind. In such scenarios, the light-emitter device 126 is configured to emit light pulses that interact with the mirror assembly 130 and the second optical window 168 such that the light pulses are directed into the second field of view 182 within the environment of the LIDAR system 100. Similar to the refractive optical window 162, second optical window 168 could be substantially transparent to light having wavelengths such as those of the emitted light pulses. For example, the second optical window 168 could include transparent materials configured to transmit the emitted light pulses with a transmission efficiency greater than 80% in the infrared wavelength range. In some embodiments, the housing 160 could include more than one second optical window 168. Furthermore, it will be understood that in some embodiments, the second optical window 168 could be a multi-element window (e.g., similar to refractive optical window 162, having a prism window portion, a flat window portion, and/or a curved window portion).

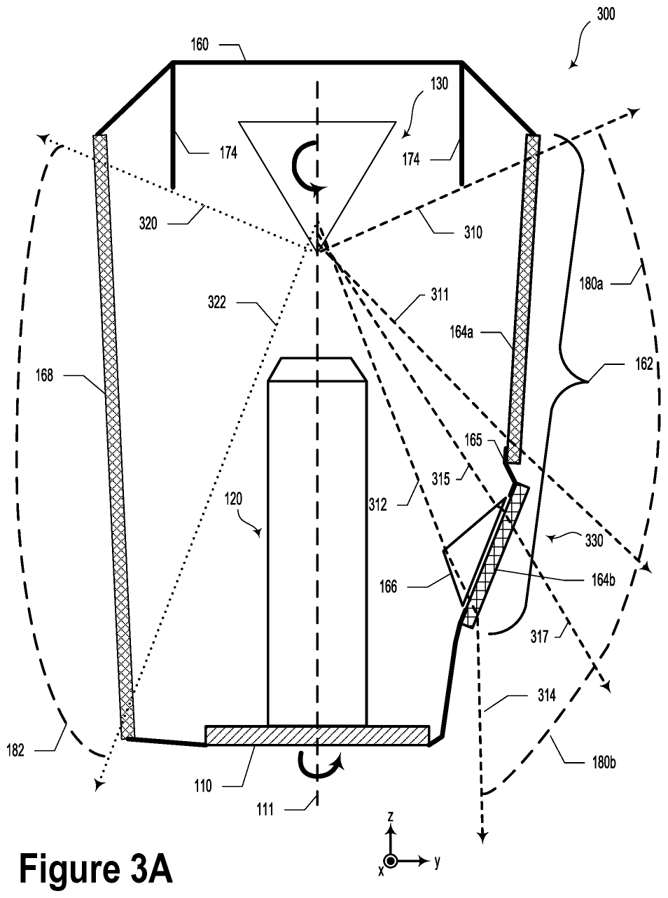

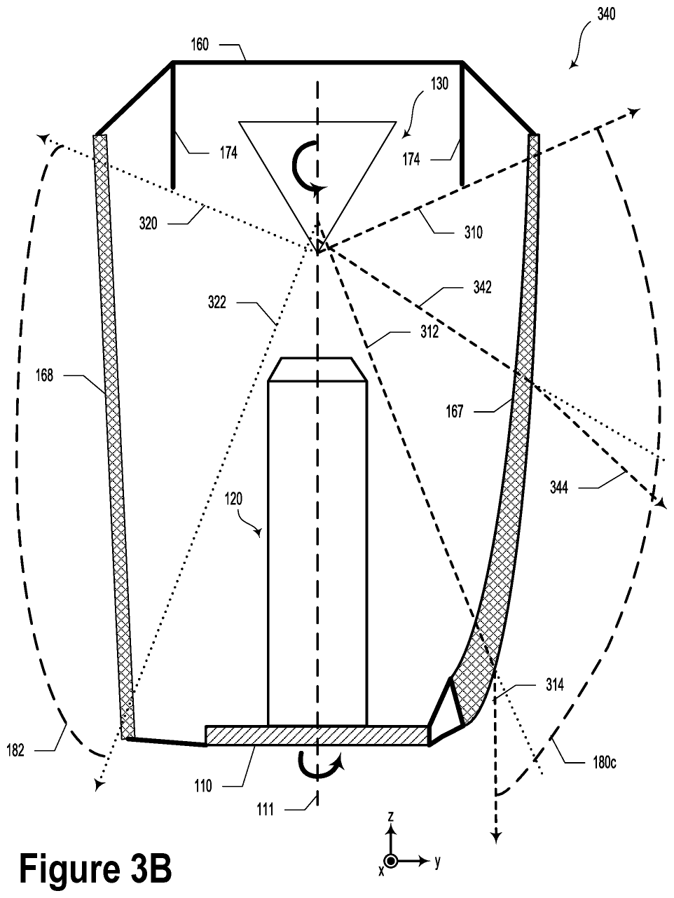

In some embodiments, the light pulses emitted or transmitted through the respective optical windows (e.g., refractive optical window 162 and second optical window 168) could form an asymmetric light emission pattern in the environment. For example, the light pulses emitted through the refractive optical window 162 are emitted within a first emission angle range and the light pulses emitted through the second optical window 168 are emitted within a second emission angle range. In such scenarios, the asymmetric light emission pattern is provided by the first emission angle range being different from the second emission angle range. Furthermore, in some embodiments, the light pulses emitted through the refractive optical window 162 could provide a disjointed field of view as illustrated in FIG. 3A.

The LIDAR system 100 includes a controller 150. In some embodiments, the controller 150 includes at least one of a field-programmable gate array (FPGA) or an application-specific integrated circuit (ASIC). Additionally or alternatively, the controller 150 may include one or more processors 152 and a memory 154. The one or more processors 152 may include a general-purpose processor or a special-purpose processor (e.g., digital signal processors, etc.). The one or more processors 152 may be configured to execute computer-readable program instructions that are stored in the memory 154. As such, the one or more processors 152 may execute the program instructions to provide at least some of the functionality and operations described herein.

The memory 154 may include, or take the form of, one or more computer-readable storage media that may be read or accessed by the one or more processors 152. The one or more computer-readable storage media can include volatile and/or non-volatile storage components, such as optical, magnetic, organic or other memory or disc storage, which may be integrated in whole or in part with at least one of the one or more processors 152. In some embodiments, the memory 154 may be implemented using a single physical device (e.g., one optical, magnetic, organic or other memory or disc storage unit), while in other embodiments, the memory 154 can be implemented using two or more physical devices.

As noted, the memory 154 may include computer-readable program instructions that relate to operations of LIDAR system 100. As such, the memory 154 may include program instructions to perform or facilitate some or all of the operations or functionalities described herein.

For example, the operations could include causing the light-emitter device 126 to emit the light pulses. In such scenarios, the controller 150 could cause a pulser circuit associated with light-emitter device 126 to provide one or more current/voltage pulses to the light-emitter device 126, which may cause the light-emitter device 126 to provide the light pulses.

The operations could also include receiving at least a first portion of reflected light pulses from the first field of view 180 as a first detected light signal. For example, at least some of the light pulses emitted from the light-emitter device 126 via the refractive optical window 162 could interact with objects in the environment in the first field of view 180 so as to provide reflected light pulses. At least the first portion of the reflected light pulses could be received by the photodetector 122. In turn, the photodetector 122 could provide the first detected light signal, which could be a photocurrent signal or a photovoltage signal.

The operations could additionally include receiving at least a second portion of the reflected light pulses from the second field of view 182 as a second detected light signal. That is, at least some of the light pulses emitted from the light-emitter device 126 via the second optical window 168 could interact with objects in the environment in the second field of view 182 so as to provide reflected light pulses. At least the second portion of reflected light pulses could be received by the photodetector 122. In such a scenario, the photodetector 122 could provide the second detected light signal, which could be a photocurrent or photovoltage signal.

Furthermore, the operations could include determining, based on the first detected light signal and the second detected light signal, a point cloud indicative of objects within the first field of view 180 and the second field of view 182. In an example embodiment, determining the point cloud could be performed by controller 150. For example, the controller 150 could determine and accumulate a plurality of spatial points based on a respective time of flight for each light pulse emitted and received. Determining the point cloud is further based on an angle of the mirror assembly 130 and the rotatable base 110.

Additionally or alternatively, the operations could include receiving an emission map. The emission map could include emission information about angles at which the light pulses are emitted into the first field of view 180 and the second field of view 182. Determining the point cloud could be further based on the emission map. In some embodiments, the emission information could include at least one of: a rotational angle of the mirror assembly 130, a position along the refractive optical window 162, or a light pulse emission vector. As an example, the emission information could be stored in a look up table (LUT). In such scenarios, the LUT could be stored in the memory 154. In carrying out the operations described herein, the controller 150 could utilize the information stored in the LUT. For instance, the controller 150 could look up a position along the refractive optical window 162 based on a present rotational angle of the mirror assembly 130. As another example, the controller 150 could determine a light pulse emission vector of a given light pulse based on the position at which the given light pulse interacts with the refractive optical window 162.

In various embodiments, the LIDAR system 100 could include at least one baffle 170. In such scenarios, the at least one baffle 170 could be configured to reduce stray light within the optical cavity 120 (e.g., light traveling internally from the light-emitter device 126 to the photodetector 122 without interacting with the environment around the LIDAR system 100). In an example embodiment, the baffle 170 could include an optically-opaque material disposed between the light-receiving axis and the light-emission axis.

The LIDAR system 100 also includes at least one beam stop 174. The beam stop 174 may be optically opaque and could be configured to block light beams from being emitted toward the optical windows 162 and/or toward the environment. In some embodiments, the beam stop 174 may be arranged within the housing 160 substantially opposite the optical cavity 120.

When light emitted from the optical cavity 120 interacts with a corner of the mirror assembly 130 (e.g., at an intersection between two different reflective surfaces 132), the light is split into two parts, one emitted forward (e.g., toward the refractive optical window 162), and one emitted backward (e.g., toward the second optical window 168). To avoid ambiguous LIDAR signals due to the two emitted pulses, the beam stop 174 may be arranged near the top of the field of view so as to block at least one of the two beams from being emitted toward the environment. Furthermore, by adjusting the beam stop 174, the field of view at the top of one side can be expanded or extended at the expense of the field of view near the top of the other side. In such scenarios, by adjusting the top beam stop position, the field of view can be distributed between the two sides at the bottom and top of the field of view respectively.

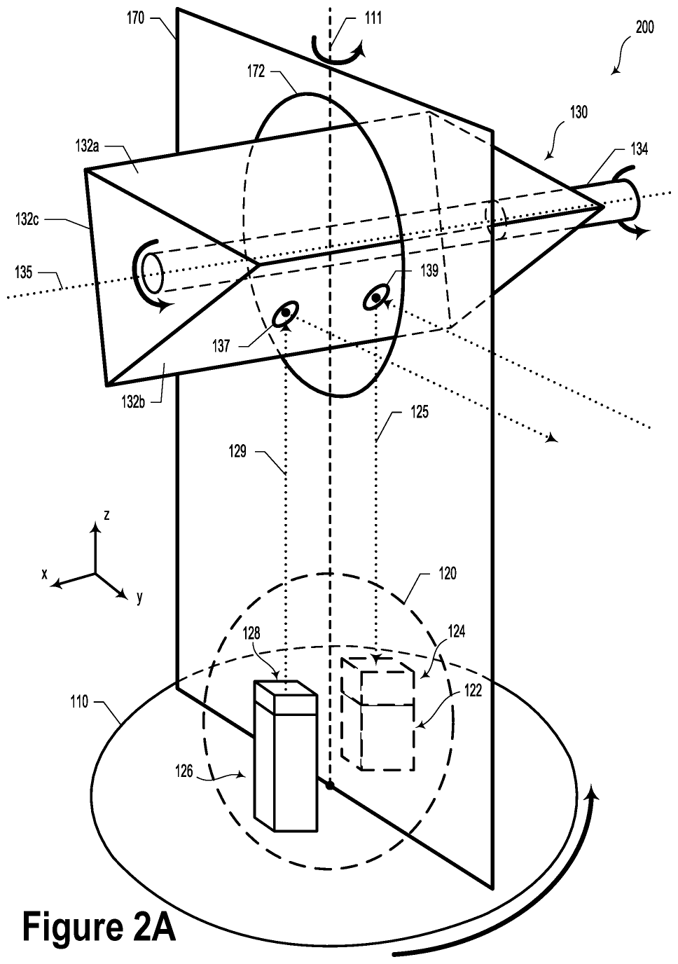

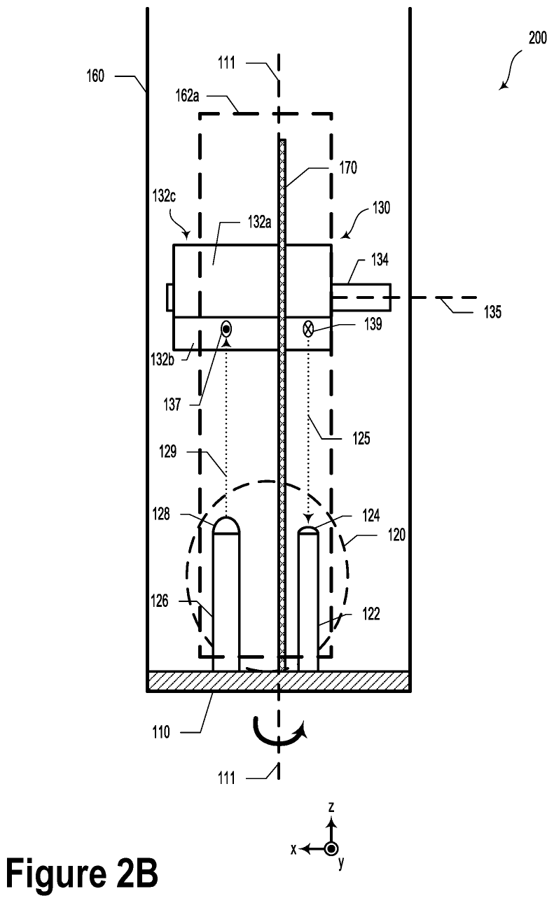

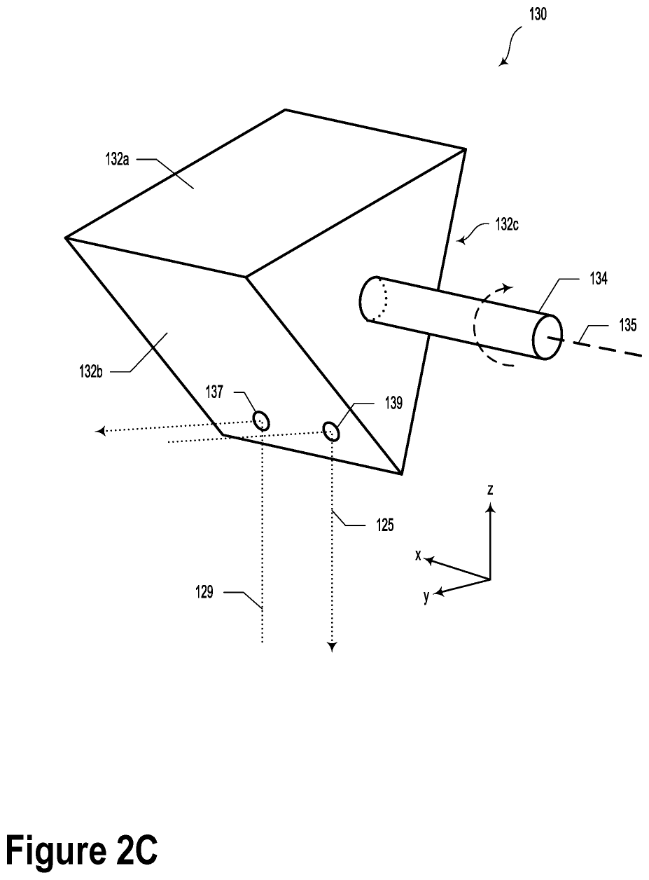

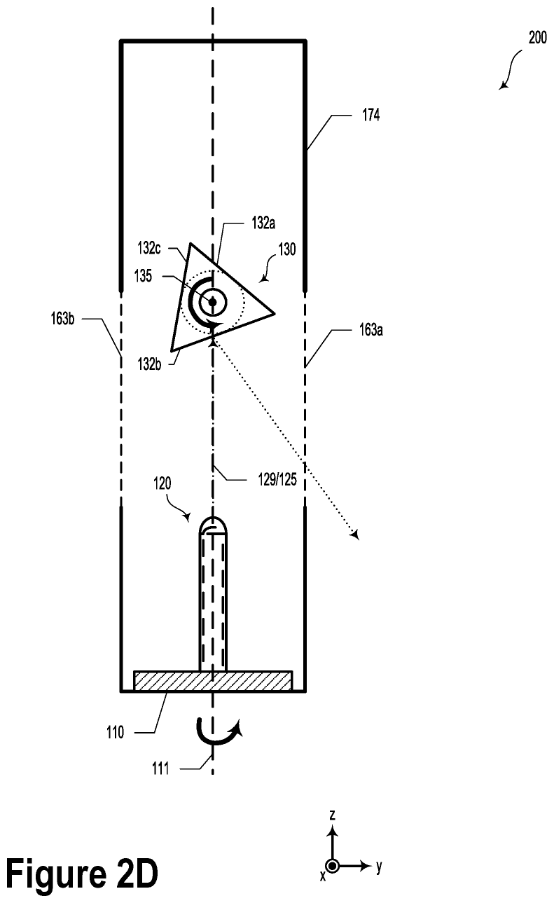

FIGS. 2A, 2B, 2C, and 2D illustrate various views and portions of LIDAR system 200. LIDAR system 200 could be similar or identical to LIDAR system 100, which is illustrated and described in relation to FIG. 1. FIG. 2A illustrates an oblique view of LIDAR system 200, according to an example embodiment. As illustrated, LIDAR system 200 could include a rotatable base 110. The rotatable base 110 could be configured to rotate about first axis 111. Furthermore, LIDAR system 200 could include an optical cavity 120, which could include light-emitter device 126, light-emitter lens 128, photodetector 122, and photodetector lens 124. Furthermore, in some embodiments, LIDAR system 200 could include a mirror assembly 130. The mirror assembly 130 could include a plurality of reflective surfaces 132a, 132b, and 132c and a shaft 134. The mirror assembly 130 could be configured to rotate about second axis 135.

In some embodiments, the light-emitter device 126 and the light-emitter lens 128 could form a light-emission axis 129. Light pulses emitted by the light-emitter device 126 could interact with reflective surface 132b at a transmission mirror region 137.

In some embodiments, the photodetector 122 and the photodetector lens 124 could form a light-receiving axis 125. Light pulses emitted by the light-emitter device 126 could be reflected or otherwise interact with the environment and could be observed at the photodetector 122 by way of a receiving mirror region 139.

As illustrated in FIG. 2A, LIDAR system 200 could include a baffle 170. The baffle 170 could include an opening 172 within which the mirror assembly 130 could be disposed. The opening 172 could be shaped so as to provide freedom for the mirror assembly 130 to rotate about the second axis 135.

FIG. 2B illustrates a side view of the LIDAR system 200 along the −y direction, according to an example embodiment. As well as other elements described above in reference to FIG. 2A, LIDAR system 200 could additionally include a housing 160 and a plurality of optical windows, such as refractive optical window 162.

FIG. 2C illustrates a portion of the LIDAR system 200 of FIG. 2A, according to an example embodiment. Specifically, FIG. 2C illustrates the mirror assembly 130. For example, mirror assembly 130 could include a plurality of reflective surfaces 132a, 132b, and 132c. The mirror assembly 130 could additionally include a shaft 134, which could be configured to rotate about second axis 135.

In some embodiments, the light-emitter device 126 could emit light pulses toward the mirror assembly 130 along a light-emission axis 129. A reflective surface 132b of the mirror assembly 130 could reflect such light pulses at a transmission mirror region 137 such that the light pulses are transmitted toward an external environment.

In such examples, light from the environment (e.g., reflected light pulses) could be reflected by the reflective surface 132b of the mirror assembly 130 at a receiving mirror region 139. In some embodiments, the received light could be directed along light-receiving axis 125 toward the photodetector 122.

FIG. 2D illustrates a view of the LIDAR system 200 along the −x direction, according to an example embodiment. The LIDAR system 200 could include the optical cavity 120 as being disposed such that light-emission axis 129 and/or light-receiving axis 125 are substantially parallel with the first axis 111.

In some embodiments, such an arrangement of the optical cavity 120 with respect to the first axis 111 could provide a substantially symmetric emission pattern in an external environment at least because light pulses emitted by the light-emitter device 126 are equally likely to be transmitted through a first optical window 163a to the right (+y direction) or through the second optical window 163b to the left (−y direction) based on the rotational position of the mirror assembly 130.

FIG. 3A illustrates a LIDAR system 300, according to an example embodiment. In some embodiments, LIDAR system 300 could be similar or identical to LIDAR system 100 or LIDAR system 200, as illustrated and described in reference to FIGS. 1 and 2A-2D. For example, LIDAR system 300 could include a refractive optical window 162 and a second optical window 168. As illustrated, the refractive optical window 162 could include a flat window portion 164a and a prism window portion 166. In some embodiments, the prism window portion 166 may be coupled to a further flat window portion 164b. For example, the prism window portion 166 could be coupled to the further flat window portion 164b with epoxy or another optically transparent material. However, in other embodiments, flat window portion 164b need not be coupled to the prism window portion 166 or need not be present at all. In some embodiments, the refractive optical window 162 could include a segmented optical window that could be configured to enable a shifted field of view.

As illustrated in FIG. 3A, an opaque material 165 could be provided proximate to an interface between the flat window portion 164a and the prism window portion 166. In example embodiments, the opaque material 165 may beneficially reduce “interface effects” due to optical element edges. These interface effects can include beam splitting, optical reflections, and ghosting effects, which may cause ambiguous or erroneous range signals.

Light pulses emitted from the optical cavity 120 could interact with the mirror assembly 130 so as to form an angular light pulse range between first maximum elevation angle 310 and first minimum elevation angle 312. Furthermore, some light pulses (e.g., light pulses emitted at first minimum elevation angle 312 and elevation angle 315) that interact with the prism window portion 166 may experience further refraction so as to form, e.g., refracted elevation angle 314 and refracted elevation angle 317. In such scenarios, light pulses transmitted via the refractive optical window 162 may provide a first field of view 180 having a wider angular extent (e.g., greater than about 80-105 degrees in elevation) compared to a flat optical window (e.g., second optical window 168), which may provide second field of view 182 with an angular range of less than 80 degrees (e.g., between second maximum elevation angle 320 and second minimum elevation angle 322). As illustrated in FIG. 3A, the first field of view 180 could include two different portions (e.g., fields of view 180a and 180b), each having its own, substantially-contiguous angle range. For example, the field of view 180a could include an angle range between maximum elevation angle 310 and minimum flat optical window angle 311. In such a scenario, the field of view 180b could include an angle range between maximum refracted elevation angle 317 and minimum refracted elevation angle 314.

In some embodiments, angles 320 and 322 could be the same or similar as angles 310 and 312. It will be understood that a variety of different angular ranges and fields of view are possible and contemplated herein. Furthermore, while several light pulse emission vectors are illustrated, it will be understood that other light pulse emission vectors are possible and contemplated.

FIG. 3B illustrates a LIDAR system 340, according to an example embodiment. LIDAR system 340 could be similar to LIDAR system 300 as illustrated in FIG. 3A. Additionally or alternatively, LIDAR system 340 could include a curved refractive optical window 167. In such a scenario, the curved refractive optical window 167 could be an optical element with continuously-varying optical power or refractive characteristics as a function of elevation angle. As an example, due to interactions with the curved refractive optical element 167, light pulses emitted at minimum emission angle 312 could be refracted along a minimum refracted angle 314. Furthermore, light pulses emitted at emission angle 342 could be refracted along a refracted angle 344. In such a manner, light pulses interacting with the curved refractive optical window 167 could be emitted into the first field of view 180 with a wider angular extent (e.g., greater than 80-105 degrees in elevation angle range) as compared to the second field of view 182 (e.g., less than 80 degrees in elevation angle range).

While FIGS. 3A and 3B illustrate certain configurations of the refractive optical window 162 and the second optical window 168, other configurations are possible. For example, in some configurations, the second optical window 168 could include a refractive optical window. In such a scenario, the refractive optical window 162 could include a first prism window portion configured to refract a portion of the light pulses in a downward angle range. Furthermore, the second optical window 168 could include a second prism window portion configured to refract a portion of the light pulses in an upward angle range. In such a configuration, the fields of view from the two optical windows may be configured to concentrate light pulses in an alternating upward/downward manner.

Alternatively, the second optical window 168 could include a curved refractive optical window. Other configurations are possible and contemplated within the scope of the present disclosure.

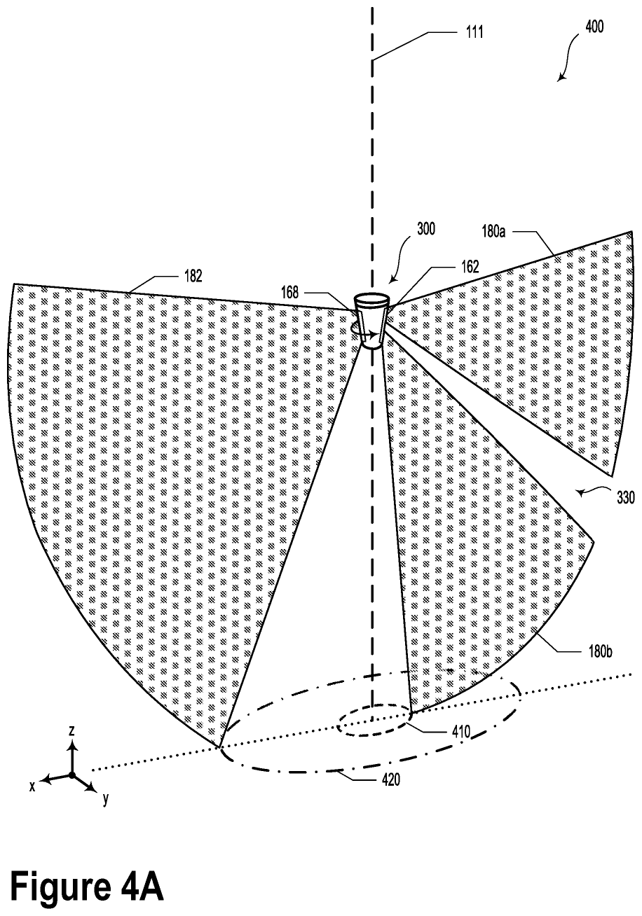

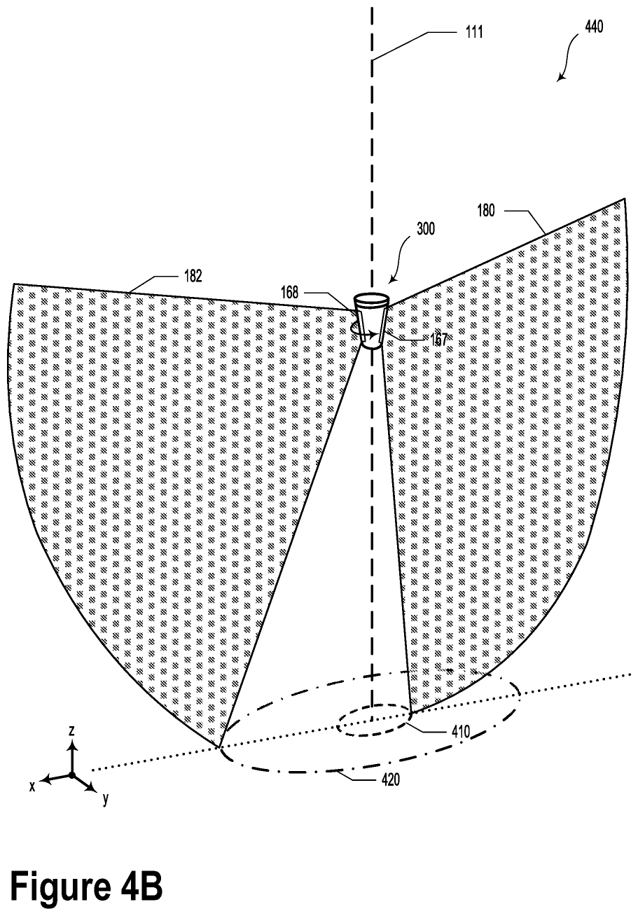

FIGS. 4A and 4B illustrate operating scenarios 400 and 440, which correspond to LIDAR systems 300 and 340, according to an example embodiments. For example, operating scenario 400 includes LIDAR system 300, as illustrated and described in reference to FIG. 3A. In such a scenario, LIDAR system 300 could be configured to emit light pulses via refractive optical window 162 within a field of view 180. Furthermore, system 300 could be configured to emit light pulses via refractive optical window 162, which could include a flat window portion 164 and a prism window portion 166. Light pulses interacting with the flat window portion 164 and the prism window portion 166 could provide two different portions of a field of view 180a and 180b. In such scenarios, the overall field of view 180 could include a drop out portion 330 without light pulse coverage. In such scenarios, field of view 182, provided by way of second optical window 168, may provide sensor coverage as the LIDAR system 300 rotates 180° about axis 111.

As illustrated in FIG. 4B, operating scenario 440 includes LIDAR system 340, as illustrated and described in reference to FIG. 3B. In such a scenario, LIDAR system 340 could be configured to emit light pulses via curved refractive optical window 167 within a field of view 180. Accordingly, LIDAR system 340 may be configured to emit light pulses over a larger angular emission range (e.g., field of view 180) as compared to field of view 182.

In operating scenarios 400 and 440, LIDAR systems 300 and 340 and corresponding fields of view 180a, 180b, and 180 could be arranged so as to provide improved object detection capabilities for locations close to the first axis 111 of the LIDAR system 300 as compared to field of view 182. For example, in operation, field of view 180 could provide a toroid-shaped sensing volume with a first minimum radius 410. Likewise, field of view 182 could be a toroid-shaped sensing volume with a second minimum radius 420. In such scenarios, the arrangement of optical elements in refractive optical window 162 could be selected so as to provide a desired field of view and/or angular light pulse emission range.

### III. Example Vehicles

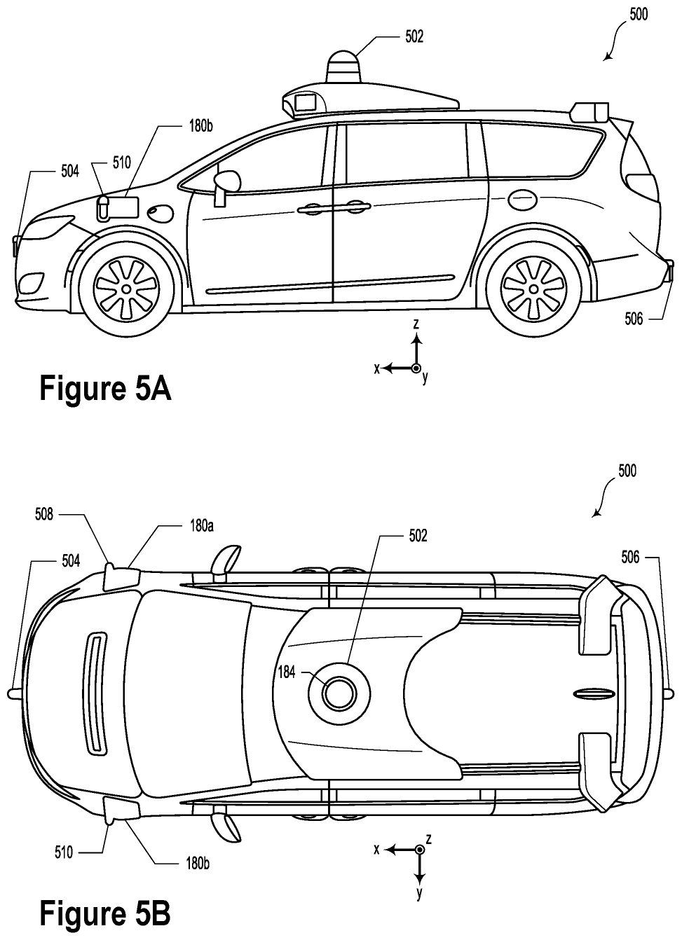

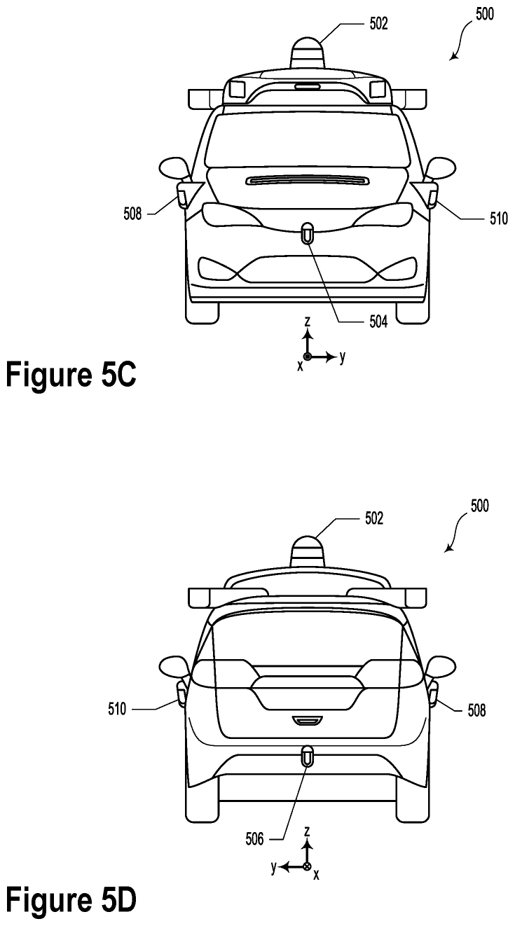

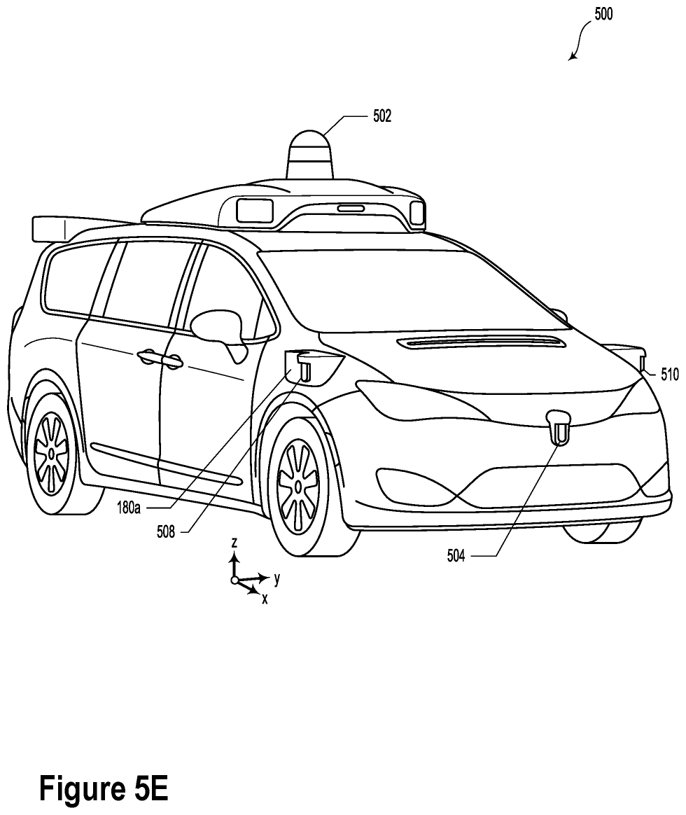

FIGS. 5A, 5B, 5C, 5D, and 5E illustrate a vehicle 500, according to an example embodiment. The vehicle 500 could be a semi- or fully-autonomous vehicle. While FIGS. 5A-5E illustrate vehicle 500 as being an automobile (e.g., a passenger van), it will be understood that vehicle 500 could include another type of autonomous vehicle, robot, or drone that can navigate within its environment using sensors and other information about its environment.

The vehicle 500 may include one or more sensor systems 502, 504, 506, 508, and 510. In some embodiments, sensor systems 502, 504, 506, 508, and 510 could include LIDAR sensors having a plurality of light-emitter devices arranged over a range of angles with respect to a given plane (e.g., the x-y plane).

One or more of the sensor systems 502, 504, 506, 508, and 510 may be configured to rotate about an axis (e.g., the z-axis) perpendicular to the given plane so as to illuminate an environment around the vehicle 500 with light pulses. Based on detecting various aspects of reflected light pulses (e.g., the elapsed time of flight, polarization, intensity, etc.), information about the environment may be determined.

In an example embodiment, sensor systems 502, 504, 506, 508, and 510 may be configured to provide respective point cloud information that may relate to physical objects within the environment of the vehicle 500. While vehicle 500 and sensor systems 502, 504, 506, 508, and 510 are illustrated as including certain features, it will be understood that other types of sensor systems are contemplated within the scope of the present disclosure.

An example embodiment may include a system having a plurality of light-emitter devices. The system may include a transmit block of a LIDAR device. For example, the system may be, or may be part of, a LIDAR device of a vehicle (e.g., a car, a truck, a motorcycle, a golf cart, an aerial vehicle, a boat, etc.). Each light-emitter device of the plurality of light-emitter devices is configured to emit light pulses along a respective beam elevation angle. The respective beam elevation angles could be based on a reference angle or reference plane. In some embodiments, the reference plane may be based on an axis of motion of the vehicle 500.

While LIDAR systems with single light-emitter devices are described and illustrated herein, LIDAR systems with multiple light-emitter devices (e.g., a light-emitter device with multiple laser bars on a single laser die) are also contemplated. For example, light pulses emitted by one or more laser diodes may be controllably directed about an environment of the system. The angle of emission of the light pulses may be adjusted by a scanning device such as, for instance, a mechanical scanning mirror and/or a rotational motor. For example, the scanning devices could rotate in a reciprocating motion about a given axis and/or rotate about a vertical axis. In another embodiment, the light-emitter device may emit light pulses towards a spinning prism mirror, which may cause the light pulses to be emitted into the environment based on an angle of the prism mirror angle when interacting with each light pulse. Additionally or alternatively, scanning optics and/or other types of electro-opto-mechanical devices are possible to scan the light pulses about the environment. Embodiments utilizing a plurality of fixed beams are also contemplated within the context of the present disclosure.

In some embodiments, a single light-emitter device may emit light pulses according to a variable shot schedule and/or with variable power per shot, as described herein. That is, emission power and/or timing of each laser pulse or shot may be based on a respective elevation angle of the shot. Furthermore, the variable shot schedule could be based on providing a desired vertical spacing at a given distance from the LIDAR system or from a surface (e.g., a front bumper) of a given vehicle supporting the LIDAR system. As an example, when the light pulses from the light-emitter device are directed downwards, the power-per-shot could be decreased due to a shorter anticipated maximum distance to target. Conversely, light pulses emitted by the light-emitter device at an elevation angle above a reference plane may have a relatively higher power-per-shot so as to provide sufficient signal-to-noise to adequately detect pulses that travel longer distances.

In some embodiments, the power/energy-per-shot could be controlled for each shot in a dynamic fashion. In other embodiments, the power/energy-per-shot could be controlled for successive set of several pulses (e.g., 10 light pulses). That is, the characteristics of the light pulse train could be changed on a per-pulse basis and/or a per-several-pulse basis.

While FIGS. 5A-5E illustrates various LIDAR sensors attached to the vehicle 500, it will be understood that the vehicle 500 could incorporate other types of sensors, such as a plurality of optical systems (e.g., cameras), radars, or ultrasonic sensors.

In an example embodiment, vehicle 500 could include a LIDAR system (e.g., LIDAR system 100) configured to emit light pulses into an environment of the vehicle 500 so as to provide information indicative of objects within a default field of view.

In example embodiments, the LIDAR system of vehicle 500 could include a rotatable base (e.g., rotatable base 110) configured to rotate about a first axis and a refractive optical window (e.g., refractive optical window 162) coupled to the rotatable base. In some embodiments, the refractive optical window includes a flat window portion (e.g., flat window portion 164) and a prism window portion (e.g., prism window portion 166). Additionally or alternatively, the refractive optical window could include a curved refractive window (e.g., curved refractive window 167). The LIDAR system also includes a mirror assembly (e.g., mirror assembly 130) coupled to the rotatable base. The mirror assembly includes a plurality of reflective surfaces (e.g., reflective surfaces 132). In such scenarios, the mirror assembly could be configured to rotate about a second axis. The second axis is substantially perpendicular to the first axis. The LIDAR system also includes a light-emitter device (e.g., light-emitter device 126) coupled to the rotatable base. The light-emitter device is configured to emit light pulses that interact with the mirror assembly and the refractive optical window such that the light pulses are directed into a first field of view within an environment of the LIDAR system.

The emitted light pulses interact with the environment to provide return light pulses. The LIDAR system may include at least one detector configured to detect at least a portion of the return light pulses. The LIDAR system also includes a controller (e.g., controller 150) having at least one processor (e.g., processor 152) and at least one memory (e.g., memory 154). The at least one processor executes instructions stored in the at least one memory so as to carry out operations as described herein.

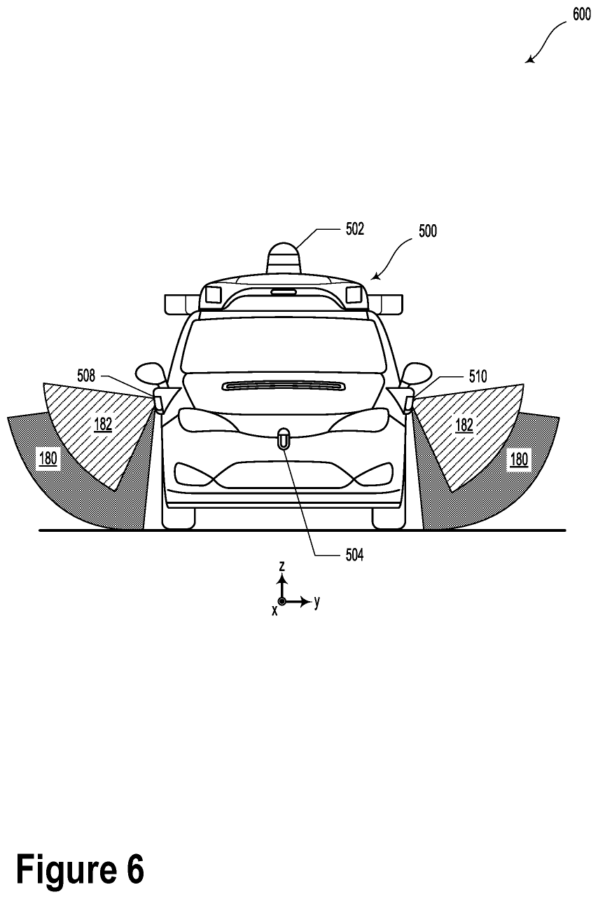

FIG. 6 illustrates an operating scenario 600, according to an example embodiment. FIG. 6 is a front view of vehicle 500. The operating scenario 600 could include LIDAR systems 508 and 510, which could similar to LIDAR systems 300 and/or 340, as illustrated and described in reference to FIGS. 3A and 3B. In such a scenario, LIDAR systems 508 and 510 could be mounted along a right side and a left side of vehicle 500, respectively. Thus, the LIDAR systems 508 and 510 could rotate about respective first axes (e.g., first axis 111 and/or the z-axis). While rotating about the first axis, LIDAR systems 508 and 510 could emit light pulses into their environments by redirecting the light pulses with the rotating mirror assembly (e.g., mirror assembly 130). In such a scenario, at least some of the light pulses may interact with the refractive optical window 162 and the second optical window 168 so as to direct some light pulses toward the first field of view 180 and the second field of view 182, respectively.

In some embodiments, at least a portion of the first field of view 180 could overlap with the second field of view 182. However, in other embodiments, the first field of view 180 need not overlap with the second field of view 182.

As illustrated in FIG. 6, the first field of view 180 could provide improved detection of objects at close range to the vehicle 500 immediately below the LIDAR systems 508 and 510. As such, the first field of view 180 could be beneficial because it could provide LIDAR coverage in conventionally uncovered fields of view. Accordingly, the operating scenario 600 could illustrate a vehicle 500 and LIDAR systems 508 and 510 that may provide improved safety in comparison to that of conventional systems.

### IV. Example Methods

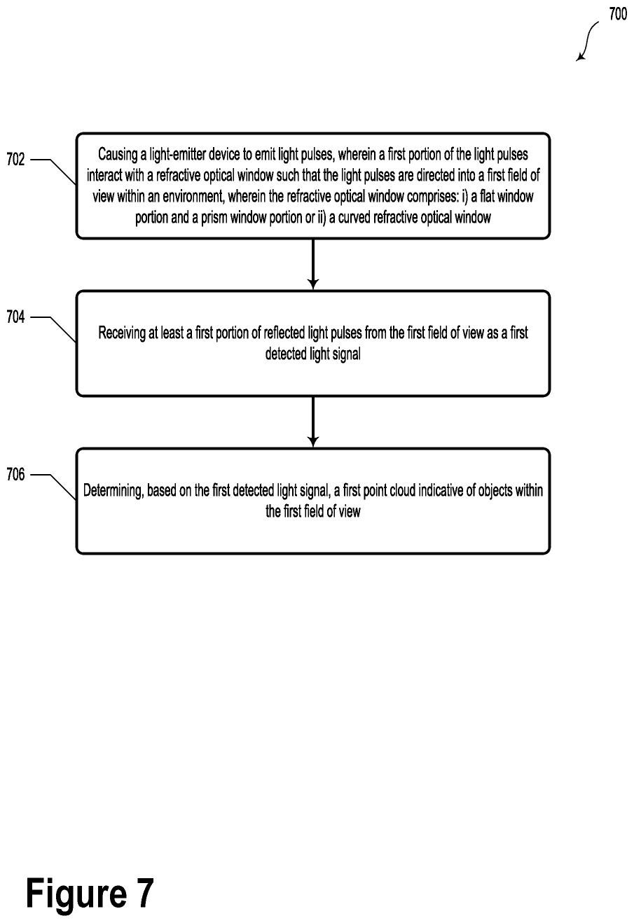

FIG. 7 illustrates a method 700, according to an example embodiment. It will be understood that the method 700 may include fewer or more steps or blocks than those expressly illustrated or otherwise disclosed herein. Furthermore, respective steps or blocks of method 700 may be performed in any order and each step or block may be performed one or more times. In some embodiments, some or all of the blocks or steps of method 700 may be carried out by controller 150 and/or other elements of LIDAR systems 100, 200, 300, and 340 as illustrated and described in relation to FIG. 1, FIG. 2A-2D, and FIGS. 3A and 3B, respectively.

Block 702 includes causing a light-emitter device to emit light pulses. A first portion of the light pulses interact with a refractive optical window such that the light pulses are directed into a first field of view within an environment. The refractive optical window includes: i) a flat window portion and a prism window portion or ii) a curved refractive optical window. In an example embodiment, causing the light-emitter device to emit light pulses could include causing a pulser circuit to send a current or voltage pulse to a laser diode bar so as to cause the laser diode bar to emit the one or more light pulses.

Block 704 includes receiving at least a first portion of reflected light pulses from the first field of view as a first detected light signal. In an example embodiment, receiving at least the first portion of reflected light pulses from the first field of view could include detecting, from the photodetector, a photosignal corresponding to light pulses emitted by the light-emitter device and reflected from one or more objects in the environment.

Block 706 includes determining, based on the first detected light signal, a first point cloud indicative of objects within the first field of view. In some embodiments, determining the first point cloud could include calculating the time of flight of a given light pulse and annotating a point cloud with a corresponding datum along a corresponding light pulse emission vector.

In some embodiments, a second portion of the light pulses interact with a flat optical window such that the light pulses are directed into a second field of view within the environment. In such scenarios, the method 700 may also include receiving at least a second portion of the reflected light pulses from the second field of view as a second detected light signal and determining, based on the second detected light signal, a second point cloud indicative of objects within the second field of view.

In some examples, the method 700 may include receiving an emission map. The emission map includes information mapping emission angles of light pulses reflected from the reflective surfaces to refracted emission angles of light pulses after they have interacted with the optical window. In such scenarios, determining the first point cloud and the second point cloud is further based on the emission map.

The arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A light detection and ranging (LIDAR) system comprising:
a rotatable base configured to rotate about a first axis;
a refractive optical window coupled to the rotatable base, wherein the refractive optical window comprises: i) a flat window portion and a prism window portion or ii) a curved refractive optical window;
a mirror assembly coupled to the rotatable base; and
a light-emitter device coupled to the rotatable base, wherein the light-emitter device is configured to emit light pulses that interact with the mirror assembly and the refractive optical window such that the light pulses are directed into a first field of view within an environment of the LIDAR system.

2. The LIDAR system of claim 1, further comprising a second optical window coupled to the rotatable base, wherein the second optical window comprises a flat window, wherein the light-emitter device is configured to emit light pulses that interact with the mirror assembly and the second optical window such that the light pulses are directed into a second field of view within the environment of the LIDAR system.

3. The LIDAR system of claim 2, wherein the first field of view comprises a first elevation angle range, wherein the second field of view comprises a second elevation angle range, wherein the first elevation angle range is greater than the second elevation angle range.

4. The LIDAR system of claim 3, wherein the second elevation angle range is 80 degrees or less, and wherein the first elevation angle range is greater than 80 degrees.

5. The LIDAR system of claim 2, wherein the first field of view and the second field of view are not fully overlapping.

6. The LIDAR system of claim 1, wherein the prism window portion comprises at least one of: a wedge prism, an equilateral prism, a Littrow prism, a right-angle prism, a penta prism, a half-penta prism, or a rhomboid prism.

7. The LIDAR system of claim 1, wherein the prism window portion comprises at least one corrective optical element configured to perform at least one optical correction on the emitted light pulses, wherein the at least one optical correction comprises at least one of: astigmatism correction, focus correction, defocus correction, or beam angle correction.

8. The LIDAR system of claim 1, wherein at least a portion of the refractive optical window comprises at least one of: a polymeric material, glass, quartz, or sapphire.

9. The LIDAR system of claim 1, wherein the prism window portion is coupled to the flat window portion by way of an index-matching material.

10. The LIDAR system of claim 1, further comprising an opaque material arranged between the flat window portion and the prism window portion.

11. The LIDAR system of claim 10, wherein at least one dimension of the opaque material is greater than a beam width associated with the emitted light pulses.

12. The LIDAR system of claim 2, further comprising a photodetector, wherein the photodetector is configured to receive a first portion of reflected light pulses by way of the refractive optical window so as to provide information indicative of objects within the first field of view, wherein the photodetector is further configured to receive a second portion of reflected light pulses by way of the second optical window so as to provide information indicative of objects within the second field of view.

13. The LIDAR system of claim 12, further comprising:
a controller comprising at least one processor and at least one memory, wherein the at least one processor executes instructions stored in the at least one memory so as to carry out operations, the operations comprising:
causing the light-emitter device to emit the light pulses;
receiving at least a first portion of reflected light pulses from the first field of view as a first detected light signal;
receiving at least a second portion of the reflected light pulses from the second field of view as a second detected light signal; and
determining, based on the first detected light signal and the second detected light signal, a point cloud indicative of objects within the first field of view and the second field of view.

14. The LIDAR system of claim 13, wherein the operations further comprise:
receiving an emission map, wherein the emission map comprises emission information about angles at which the light pulses are emitted into the first field of view and the second field of view, wherein determining the point cloud is further based on the emission map.

15. The LIDAR system of claim 14, wherein the emission information comprises at least one of: a rotational angle of the mirror assembly, a position along the refractive optical window, or a light pulse emission vector.

16. The LIDAR system of claim 14, wherein the emission information comprises a look up table (LUT), wherein the LUT is stored in the at least one memory.

17. A method comprising:
causing a light-emitter device to emit light pulses, wherein a first portion of the light pulses interact with a refractive optical window such that the light pulses are directed into a first field of view within an environment, wherein the refractive optical window comprises: i) a flat window portion and a prism window portion or ii) a curved refractive optical window;
receiving at least a first portion of reflected light pulses from the first field of view as a first detected light signal; and
determining, based on the first detected light signal, a first point cloud indicative of objects within the first field of view.

18. The method of claim 17, wherein a second portion of the light pulses interact with a flat optical window such that the light pulses are directed into a second field of view within the environment, wherein the method further comprises:
receiving at least a second portion of the reflected light pulses from the second field of view as a second detected light signal; and
determining, based on the second detected light signal, a second point cloud indicative of objects within the second field of view.

19. The method of claim 18, further comprising receiving an emission map, wherein the emission map comprises emission information about angles at which the light pulses are emitted into the first field of view and the second field of view, wherein determining the first point cloud and the second point cloud is further based on the emission map.

20. A vehicle comprising:
a light detection and ranging (LIDAR) system comprising:
a rotatable base configured to rotate about a first axis;
a refractive optical window coupled to the rotatable base, wherein the refractive optical window comprises: i) a flat window portion and a prism window portion or ii) a curved refractive optical window;
a mirror assembly coupled to the rotatable base; and
a light-emitter device coupled to the rotatable base, wherein the light-emitter device is configured to emit light pulses that interact with the mirror assembly and the refractive optical window such that the light pulses are directed into a first field of view within an environment of the LIDAR system.
